(19) United States
(12) Patent Application Publication
(10) Pub. No.: US 2006/0087250 A1
(43) Pub. Date: Apr. 27, 2006

(54) Method and circuit for igniting and powering a high intensity discharge lamp

(76) Inventor: Ronald M. Fiorello, Tewksbury, MA (US)

Correspondence Address: Ms. Sandi Basti;OSRAM SYLVANIA, INC., I.P. Law Dept., 100 Endicott St., Danvers, MA, 01923-3623, US

(21) Appl. No.: 10/972,611

(22) Filed: Oct. 25, 2004

(51) Int. Cl. H05B 37/02

(52) U.S. Cl. 315/212

(57) ABSTRACT

A circuit for igniting a high intensity discharge lamp is disclosed. The circuit comprises a rectifier circuit coupled to receive an alternating current line voltage. A flyback converter coupled to the rectifier circuit has an inductor comprising a primary inductive winding and a secondary inductive winding. Finally, an open circuit voltage circuit coupled to the secondary inductive winding couples a supplement inductive winding to the secondary winding during ignition. A method of igniting a high intensity discharge lamp is also disclosed. The method comprises the steps of generating a DC voltage for the high intensity discharge lamp by way of a flyback converter; providing an inductive winding comprising a primary inductive winding and a secondary inductive winding in the flyback converter; and coupling a supplement inductive winding couple to the secondary winding during ignition.

### FIELD OF THE INVENTION

The present invention generally relates to circuits for powering discharge lamps, and more particularly to a method and circuit for igniting and powering a high intensity discharge lamp.

### BACKGROUND OF THE INVENTION

In starting a high intensity discharge (HID) lamp, the lamp experiences three phases. These phases include breakdown, glow discharge, and thermionic arc. Breakdown requires a high voltage to be applied between the electrodes of the lamp. Following breakdown, the voltage must be high enough to sustain a glow discharge and heat the electrodes to thermionic emission. Once thermionic emission commences, current must be maintained in the run-up phase until the electrodes reach steady-state temperature. After achieving the arc state, the lamp can be operated with a lower level of current in the steady state operating mode.

For ignition of the lamp, the lamp electrodes must be provided with a high voltage for a specified duration in the pre-breakdown period. Conventional lamps are characterized by a minimum voltage level and time duration in achieving breakdown. HID lamps require a high ignition voltage (e.g., 1000 to 5000 Vᵣₘₛ) to initiate the plasma discharge when cold. Lamp input power is typically 5-10 times higher during lamp ignition than the rated steady state lamp power because of high transient power losses. This voltage creates a high intensity electrical field applied to the electrodes that initiates the discharge. The high voltage requirements for breakdown can be achieved through pulse resonant circuits. The frequency at which the circuit achieves resonance and the resultant resonant voltage varies from circuit to circuit due to variation in component tolerances. Because lamp starting voltage depends on inverter input voltage, it is important that the DC bus voltage is maintained by keeping it in a definite range as long as possible before the lamp ignites.

However, the stress on a ballast during ignition can be significant. This is especially true with regard to a power transistor within a flyback converter. That is, there is a voltage stress on the primary side power transistor during ignition because the voltage reflected back to the power transistor is proportional to the ratio of the primary and secondary windings (Np/Ns) of the flyback transformer. Accordingly, there is a need for a ballast which provides reduced stress on the power transistor during ignition.

Once the arc has been established, it is beneficial to provide a constant power to the lamp to assure a constant and relible light output. Typically, electronic ballasts regulate lamp power when operating high intensity discharge lamps by sensing the lamp current and the lamp voltage. The sensed lamp current and voltage are multiplied to get the wattage. The multiplication could be achieved using a micro-controller or microprocessor. The wattage is then compared to a reference wattage. A feedback loop is provided in such a way that the error that resulted from this comparison is converted to a signal adjusting the lamp current so that the measured lamp power is equal to the reference power.

Prior art electronic ballasts for HID lamps receive an alternating line current, such as the alternating line current provided by a voltage source 10 as shown in FIG. 1. The current is provided to a rectifier circuit 12, which generates an output to a boost converter 14. The boost converter is typically controlled by a power factor correction controller 16. The boost converter typically has it own voltage control loop to maintain its output voltage higher than the input voltage. The boost converter is then followed by a power processing stage comprising a DC-DC converter 18, such as a buck converter or other suitable type of DC-DC converter, that again has its own control loop, such as a pulse width modulation (PWM) controller 20, and is used to maintain a constant voltage or current output and to perform the necessary voltage conversion and conditioning. The power processing stage is coupled to an inverter 22 (controlled by a corresponding inverter driver circuit 24) which delivers power to the lamp 26.

However, the power processing stage results in additional power losses as well as additional components which lead to increased size and higher cost. In manufacturing electronics generally, any reduction in the necessary parts can be significant. In the field of electronic ballasts, any improvement which can reduce material cost is significant. For example, the reduction or elimination of conventional circuitry can reduce part count and reduce cost significantly. Therefore, a need exists for a ballast that does not require a separate power processing stage in order to regulate the power that is supplied to an HID lamp.

### OBJECTS OF THE INVENTION

It is an object of the present invention to provide a universal input voltage electronic ballast to reliably regulate lamp power from a power factor corrected (PFC) flyback converter stage, which eliminates any need for a separate DC-DC converter power processing stage and avoids its associated energy losses, size, weight and cost.

It is a further object of the present invention to provide a microprocessor control circuit arrangement for programmable start of a universal voltage electronic ballast having an active flyback, power regulated power factor corrector and an inverter.

It is another object of the present invention to provide a microprocessor control circuit arrangement for programmable start of a universal voltage ballast having an additional winding on the flyback transformer to provide the necessary open circuit voltage to ignite the lamp.

It is another object of the present invention to provide a microprocessor control circuit arrangement for average power regulation and programmable start of a universal voltage ballast having an additional winding flyback transformer for open circuit voltage, an active flyback, power regulated power factor corrector and an inverter.

Accordingly, it is desirable to provide an improved electronic ballast for igniting and regulating power in a high intensity discharge lamp.

### SUMMARY OF THE INVENTION

A circuit for igniting and powering a high intensity discharge lamp is disclosed. The circuit according to one embodiment of the invention comprises a rectifier circuit coupled to receive an alternating current line voltage. A flyback converter coupled to the rectifier circuit has a flyback transformer comprising a primary inductive winding, a secondary inductive winding, and a supplemental inductive winding. An open circuit voltage circuit coupled to the secondary inductive winding couples the supplemental inductive winding to the secondary winding during ignition of the lamp.

A method of igniting and powering a high intensity discharge lamp is also disclosed. The method comprises the steps of generating a DC voltage for the high intensity discharge lamp by way of a flyback converter; providing a flyback transformer comprising a primary inductive winding, a secondary inductive winding, and a supplemental inductive winding in the flyback converter; and coupling the supplemental inductive winding to the secondary winding during ignition.

### BRIEF DESCRIPTION OF THE DRAWINGS

FIG. 1 is a block diagram of a conventional circuit for igniting and powering a high intensity discharge lamp;

FIG. 2 is a block diagram of circuit for igniting and powering a high intensity discharge lamp, according to an embodiment of the present invention;

FIG. 3 is a more detailed block diagram of the circuit of FIG. 2, according to an embodiment of the present invention;

FIG. 4 is a detailed circuit diagram of a rectifier circuit, a flyback converter, and a flyback control circuit, according to an embodiment of the present invention;

FIG. 5 is a detailed circuit diagram of an inverter and inverter driver circuit, according to an embodiment of the present invention;

FIG. 6 is a detailed circuit diagram of a power control circuit, according to an embodiment of the present invention;

FIG. 7 is a diagram that descrined the shaping of a sinusoidal input current, according to an embodiment of the present invention;

FIG. 8 is a flow diagram showing a method of igniting and powering a high intensity discharge lamp, according to an embodiment of the present invention; and

FIG. 9 is a flow diagram showing a method of igniting and powering a high intensity discharge lamp, according to an alternate embodiment the present invention.

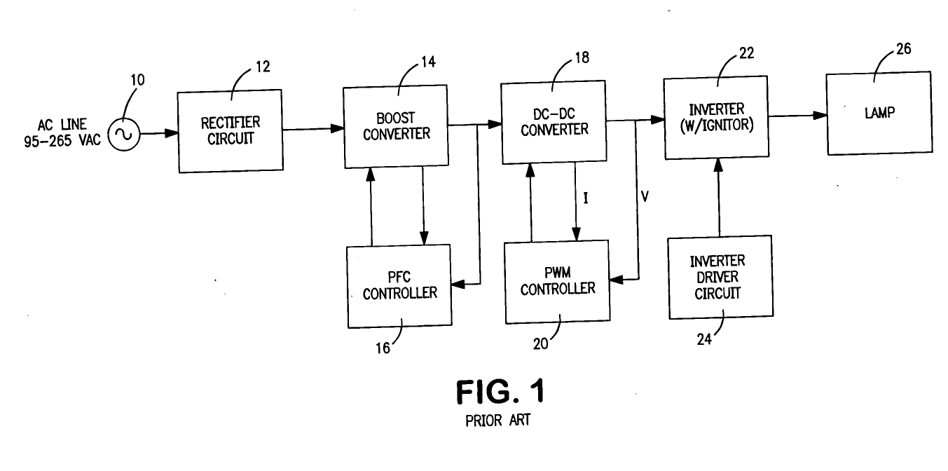

### DETAILED DESCRIPTION OF THE PREFERRED EMBODIMENTS

The various embodiments of the present invention relate to an electronic ballast and method for igniting and powering a high intensity discharge lamp from a universal input AC line voltage. The present invention includes an active power factor corrector circuit configured as a flyback converter to provide power factor correction and power regulation in a single power processing stage. Average lamp power is regulated by a micro-controller driving a Transition Mode (TM) or critical conductance mode power factor controller. The output current and voltage of the flyback converter are varied to regulate the lamp power. Either the DC output bus power can be regulated, or with the addition of a current and voltage transformer, the inverter AC output power can be regulated. Because the average is taken of a digital PWM output voltage based on a table lookup and is used to regulate the power of the flyback converter, the need for an intermediate DC-DC converter stage and its associated cost and size are eliminated. Thus, the single stage, single switch flyback converter provides both power factor correction and load power regulation.

Additionally, the present invention provides a supplemental winding on a flyback transformer in order to ignite the lamp with lower stress on the components of the flyback converter. The additional winding on the flyback transformer generates the necessary open circuit voltage for the lamp. The additional winding reduces the voltage stress on the primary side power switch during ignition since the voltage reflected back to the primary is proportional to the ratio of Np/Ns of the flyback transformer. The additional winding is switched out of the circuit by the micro-controller once ignition of the lamp occurs.

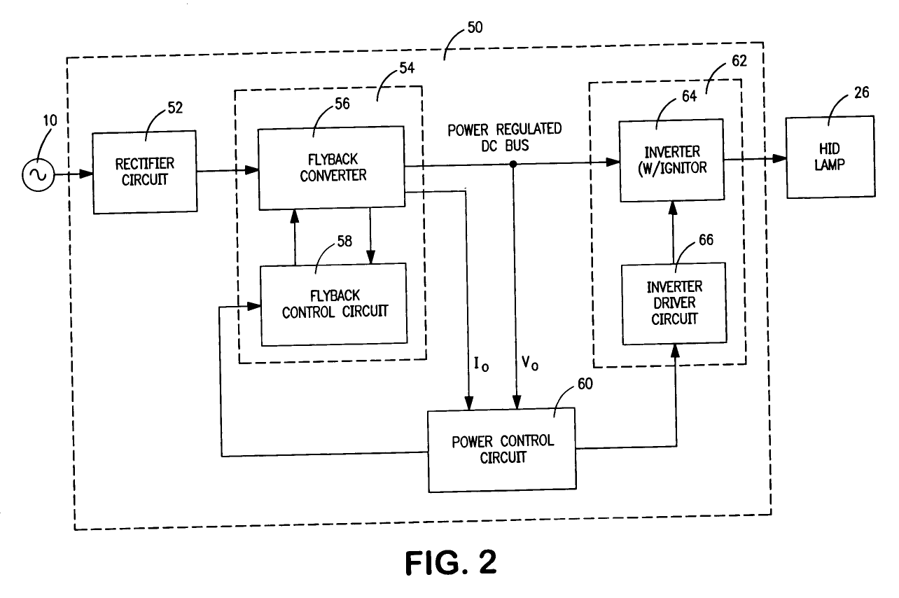

Turning to FIG. 2, a block diagram of a circuit for igniting and powering a high intensity discharge lamp according to an embodiment of the present invention is shown. The circuit is used to regulate HID lamps powered from a source 10 such as a 120 or 277 V AC line, for example. In particular, an electronic ballast 50 for energizing an HID lamp 26 comprises a rectifier circuit 52 coupled to an AC line source 10 and an active power factor corrector circuit 54. The active power factor corrector circuit 54 comprises a single stage, single switch converter configured as a flyback converter 56 providing AC-DC conversion and a flyback control circuit 58, providing power factor correction and power regulation in a single power processing stage. An inverter section 62 comprises an inverter circuit 64 having an igniter and receiving the output of the flyback converter 56 by way of a power regulated DC bus, and an inverter driver circuit 66. As will be described in more detail below, the inverter circuit 64 provides the necessary voltage to ignite and power the HID lamp.

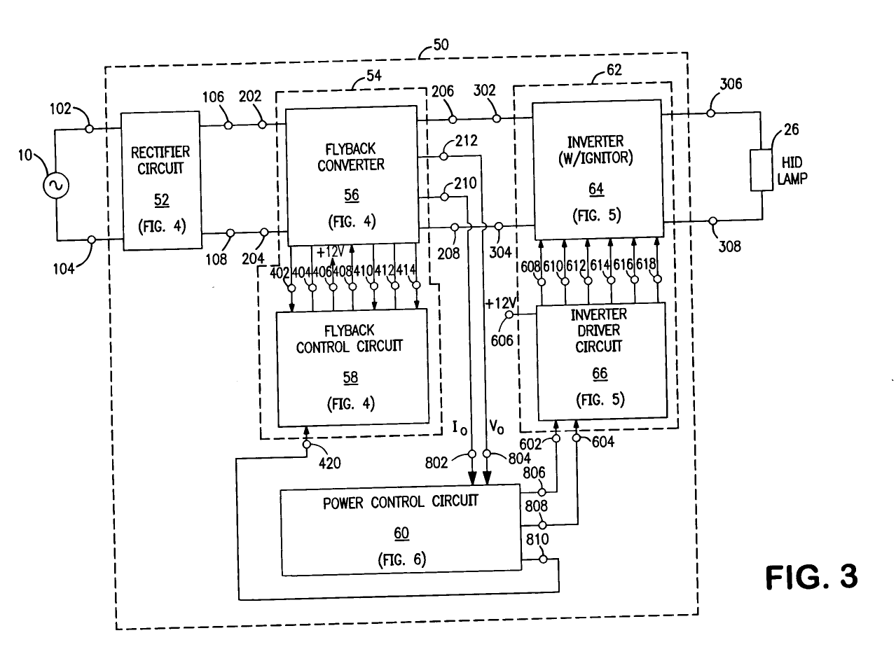

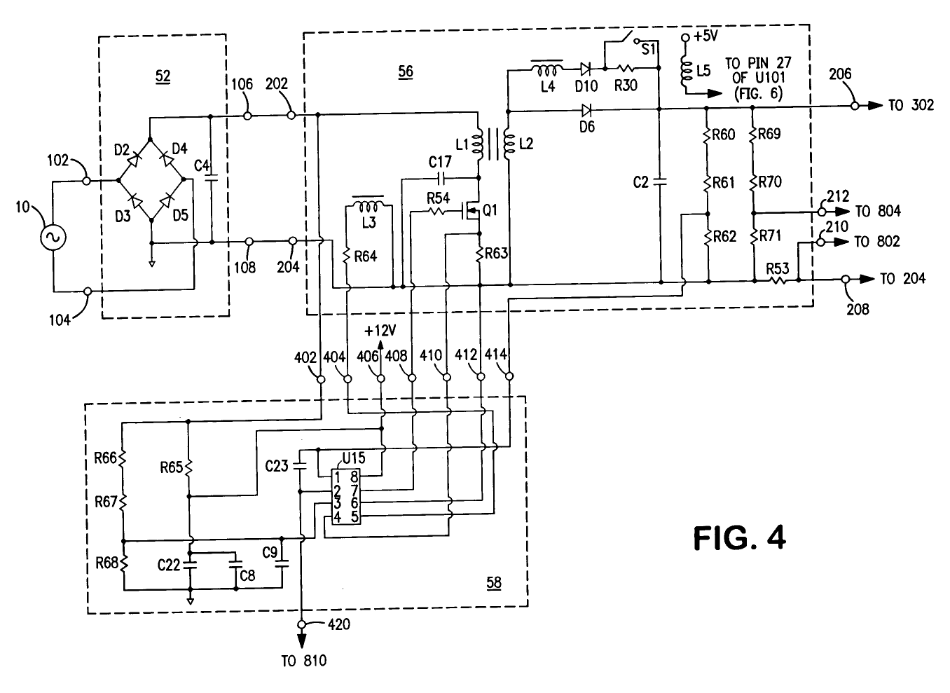

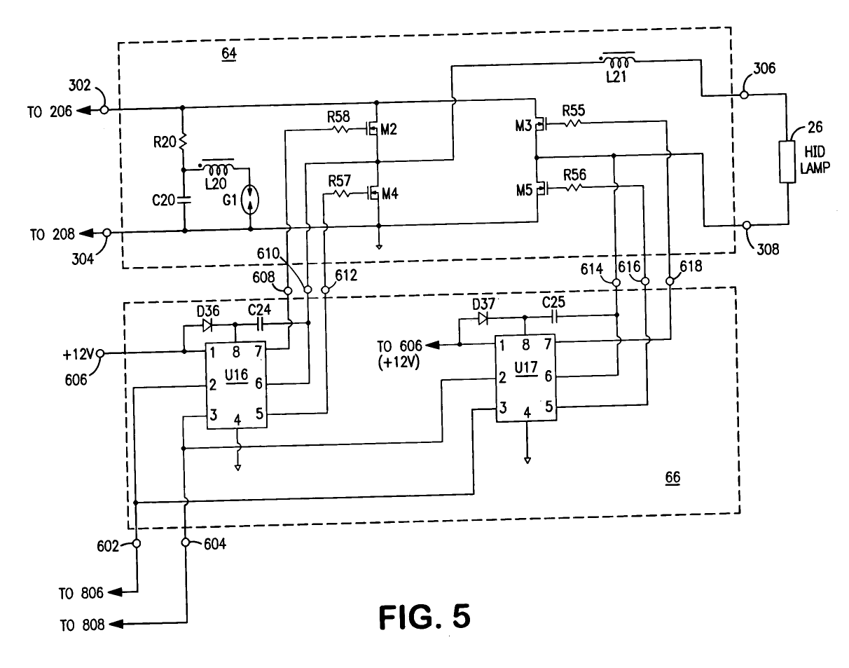

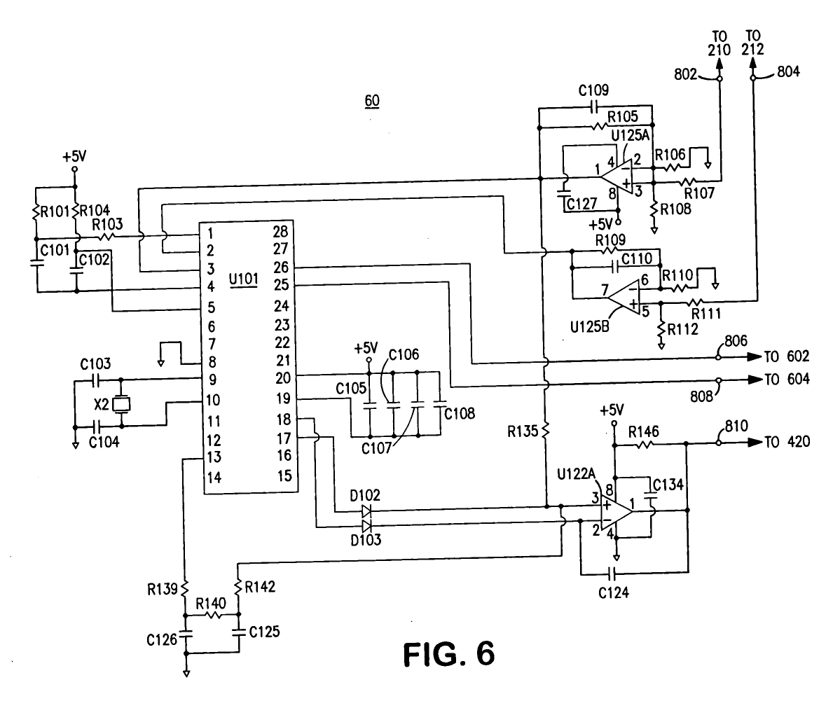

A single loop power regulation method according to an embodiment of the present invention is employed to maintain constant power to the lamp. The various connections between the circuits of FIG. 4-6 are shown in more detail in FIG. 3 to enable an understanding of the interaction between the various circuits. As will be described in more detail in reference to FIG. 4, the power factor corrector circuit 54 feeds an inverter to provide AC excitation to drive an HID lamp. The inverter circuit 64 and the inverter driver circuit 66 will be described in more detail in reference to FIG. 5. Finally, the power control circuit 60 detects the current and voltage output by the flyback converter 56, as will be described in more detail in reference to FIG. 6.

Turning now to FIG. 4, a circuit diagram of the active power factor correction circuit according to an embodiment of the present invention is shown. The circuit, which is generally an AC to DC converter section, comprises a rectifier circuit 52 having diodes D2-D5 and a capacitor C4 coupled across the output of the rectifier circuit 52. The flyback converter 56 coupled to the rectifier circuit comprises a flyback transformer having windings L1-L3. A capacitor C17 is coupled between the node at the L1 winding and transistor Q1 and ground. A power switching transistor Q1 is driven via an input resistor R54 to periodically energize the flyback transformer inductor L1 from a rectified voltage. An output rectifier diode D6 is connected to the secondary winding L2 of the flyback transformer. An output energy storage capacitor C2 is coupled across the output of the flyback circuit. According to one embodiment of the present invention, the windings of the conductors are configured such that the L1 to L2 turn ratio is 1 to 0.65, where L1 has 30 turns, the L1 to L3 turn ratio (zero current winding) is 1 to 0.15, and L1, L2, and L3 are wound on TDK PQ40/40 cores.

An open circuit voltage circuit comprising a supplemental winding L4 is coupled to winding L2 by a switch S1. The supplemental winding L4 is coupled in series with a diode D10 and a resistor R30. The supplemental winding L4 preferably has twice the number of turns of L2. Switch S1 may be implemented by a relay or an isolated semiconductor switch, for example. Switch S1 is closed prior to ignition of the lamp to couple winding L4 in series with winding L2, and then is opened after ignition to decouple winding L4 from winding L2. Switch S1 may be controlled by the microprocessor U101 (see FIG. 6), for example, receiving a signal from pin 27 of U101. That is, a coil L5 coupled between +5 volts and U101 pin 27 opens or closes switch S1 in dependence on the signal provided at U101 pin 27. The flyback section of the power factor corrector circuit preferably operates in the critical conduction mode to minimize switching losses, and incorporates a Transition Mode (TM) controller regulating a constant output power via a micro-controller commanded reference.

The flyback converter 56is also coupled to the flyback control circuit 58 which comprises a power factor controller circuit having a power factor controller U15, such as an SGS Microelectronics L6561 TM controller. The power factor controller U15 is provided with a voltage feedback loop through a resistor divider R60-R62, a current feed back loop through resistor R63, and a power regulation loop. The resistor divider network comprising resistors R60, R61 and R62 generates a voltage associated with the open-circuit output of the flyback converter 56. A second resistor network comprising resistors R69, R70, R71 and R41 generates a feedback current signal at output 210 and a feedback voltage signal at output 212. As will be described in more detail in reference to FIG. 6, the feedback voltage and feedback current signals are coupled to the power control current 60 to generate a power control signal which is fed back by way of a power control loop to the power factor controller U15. Based upon the value of the power control signal, the power factor controller regulates the power of the flyback circuit 56 after ignition by controlling the frequency and the duty cycle at which transistor Q1 is driven.

The AC to DC converter section shapes the sinusoidal input current to be in phase with sinusoidal input voltage and regulates the output power of the flyback converter through the power command control loop coupled to the power transistor Q1 by way of a resistor R54. The power factor controller circuit U15 is preferably provided with a peak current sense feature for zero current turn-on and near zero voltage turn-off of the power transistor. A resistor network comprising resistors R66, R67 and R68 provides the voltage at the input of the flyback converter to the power factor controller U15. A small ceramic capacitor C9, such as a 0.1 uF capacitor, is preferably coupled to pin 3 of U15 to reduce noise at that pin. A resistor/capacitor circuit comprising R65 and C22 is coupled to the rectifier circuit output 106,108 and generates a bias during start-up of the lamp to provide an auxiliary supply to U15 until the lamp lights. A 0.1 uf capacitor C8 is preferably coupled to pin 8 of U15 to reduce noise at that pin. According to one embodiment of the invention, Q1 is an IXS24N100 24A/1000V power transistor from IXYS Corporation. R41 is a 2W, 5% resistor. comprising four 0.62 ohm resistors in parallel. D10 is a 8A/600V diode from IXYS Corporation. The remaining capacitors, resistors, and diodes preferably have the following values set forth in Table 1.

TABLE 1

| Component | Value |
|---|---|
| C4 | .22 uf/500 V |
| C17 | 560 uF/350 V |
| C2 | 470 uF/400 V |
| C22 | 22 uF/50 V |
| C23 | 1 uF/50 V |
| C21 | 2200 pF/1 kV |
| D2, 3, 4, 5 | 3 A/600 V |
| R54 | 22 ohms |
| R63 | .15 ohms |
| R64 | 34k ohms |
| R60, 61 | 124k ohms |
| R62 | 2.49k ohms |
| R66, 67 | 750k ohms |
| R68 | 9.1k ohms |
| R65 | 150k ohms |
| R69, 70 | 250k ohms |
| R71 | 5k ohms |

Turning now to FIG. 5, a circuit diagram of the inverter circuit 64 and the inverter driver circuit 66 according to an embodiment of the present invention is shown. In particular, a typical igniter circuit comprises a resistor R20, a capacitor C20, an inductor L20-L21, and a spark gap generator G1. The igniter circuit is coupled across the lamp to ignite the lamp, as is well known in the art. Inverter driver circuit 66 includes gate drivers U16 and U17, each of which preferably comprises an IR2101 gate driver from International Rectifier. The gate drivers U16 and U17 control transistors M2 and M4 and transistors M3 and M5, respectively, which comprise an H bridge converter for converting the DC voltage generated by the flyback converter 56 to an AC voltage. Preferably, transistors M2, M3, M4, and M5 are 12A/600V transistors, such as 20N60S transistors from Infineon Corporation. Capacitors C24 and C25 are 1 uF/50V capacitors, diodes D36 and D37 are 1A/600V diodes, and resistors R55-58 are 22 ohm resistors.

Turning now to FIG. 6, a block diagram of a power control circuit according to an embodiment of the present invention is shown. The power control circuit preferably comprises a microprocessor, such as a Microchip PIC 18C242 or similar microcontroller, and includes a first input terminal 802 for monitoring the output current (via resistor R53 of FIG. 4) of the flyback converter 56, and a second input terminal 804 for monitoring the DC bus voltage (via resistive divider R69, R70, R71 of FIG. 4) at the output of the flyback converter. The first input terminal is coupled to a differential OP-AMP U125A, gain setting resistors R105, R106, R107, R108, and frequency compensation capacitor C109. The first input terminal enables a single stage, single switch power factor corrected AC-DC converter and constant average lamp power that is scalable to other power levels via the proper adjustment of R105, R106, R107 and R108 or via a change in look-up table ROM values. A second input terminal 804 is coupled to coupled to OP-AMP U125B, gain setting resistors R109, R110, R111, R112, and frequency compensation capacitor C110. The output of the microprocessor U110 is coupled to a current amplifier comprising OP-AMP U122A. In particular, U122A is driven by the U101 by way of diodes D102 and D103, which are preferably 1N4148 diodes, until the lamp lights, when the power regulation circuit takes over. An associated low pass filter comprising R139, C126, R140 and C125 is also coupled to the other input of OP-AMP 122A to provide power regulation. The duty cycle of the signal at pin 13 of U101, which is based upon the output voltage at the output of U125B coupled to pin 2 of U101, is based upon the values in a lookup table as depicted in Table 2 below.

TABLE 2

| Output Voltage | Duty Cycle |
|---|---|
| 1.310484 | 0.66129 |
| 1.315249 | 0.65927 |
| 1.320015 | 0.65726 |
| 1.324780 | 0.65524 |
| 1.329545 | 0.65323 |
| 1.334311 | 0.64919 |
| 1.339076 | 0.64718 |
| 1.343842 | 0.64516 |
| 1.348607 | 0.64315 |
| 1.353372 | 0.64113 |
| 1.358138 | 0.63911 |
| 1.362903 | 0.63710 |
| 1.367669 | 0.63508 |
| 1.372434 | 0.63105 |

The low pass filter couples an average value voltage to pin 3 of U122A. The output of the OP-AMP 122A is fed back (via output 810) to the flyback control circuit 58, which controls the frequency and duty cycle that transistor M1 is turned on based upon the value of the output of OP-AMP 122A. That is, the output of OP-AMP 122A comprises a power control signal which controls the power generated by the flyback converter.

It should be noted that the lamp current and voltage which are used to regulate the lamp power are monitored by microprocessor U101 (FIG. 6) to detect any fault conditions that may occur. If a fault condition does occur, the microprocessor sends a command (by way of diode D102, OP-AMP U122A, and output 810) to effectuate shutdown of the flyback converter, thus providing protection for the ballast electronics. Preferably, the resistors and capacitors in the circuit of FIG. 6 have the following values: R101,103,104=1 k ohm, R105,108=25 k ohm, R106,107,110,111,139,140=10 k ohm, R109,112=39.2 k ohm, R133=40 k ohm, R142,146=5 k ohm, C101,102,124,125,126,134,139=1 uF, C103,104=18 pF, C109,110=470 pF.

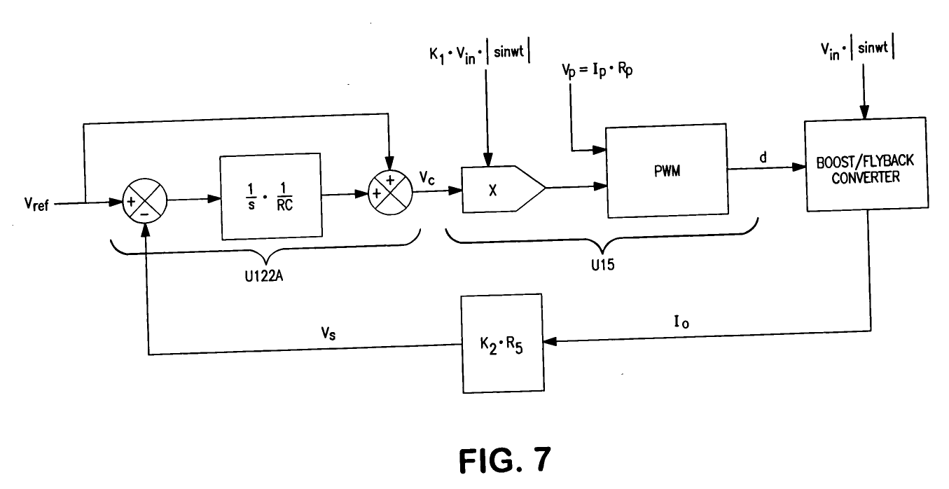

Turning now to FIG. 7, a block diagram describes the shaping of a sinusoidal input current according to an embodiment of the present invention. An embedded microcontroller, such as U101 of FIG. 6, measures lamp power by sampling lamp voltage and current. The voltage is used as an index into a look-up table to determine the appropriate current command to arrive at the correct lamp power. The micro-controller provides a digital pulse width modulated output whose duty ratio is proportional to the measured lamp voltage. This signal is then averaged and used as the reference for the current error amplifier, for example OP-AMP 122A of FIG. 6. That is, the summer blocks and error amplification could be performed by OP-AMP 122A which receives V_{ref} at pin 3 and outputs a power control signal V_{c} representing an error signal. The output V_{c} of this error amplifier is used instead of the error amplifier internal to a power factor controller as a variable input to the multiplier. This input is multiplied by a sample of the rectified line voltage to provide a rectified AC reference. The reference is compared to the power switch current to shape sinusoidal input current such that the input current is Iᵢₙ=K*sin wt, where K is the variable DC term controlled by the power control loop. The multiplication and pulse width modulation could be performed by the power factor controller U15, which receives the sensed peak voltage Vₚ and outputs a duty cycle signal “d” coupled to the flyback converter. The output current Iₒ is then modified by an amplification factor K₂ to generate a voltage input Vₛ to U122A. The power factor controller voltage amplifier provides a regulated open circuit bus voltage of approximately 300 VDC before lamp ignition is initiated. Once lamp ignition has occurred, the power regulation loop controls and regulates lamp power based on a lookup table stored in onboard program ROM.

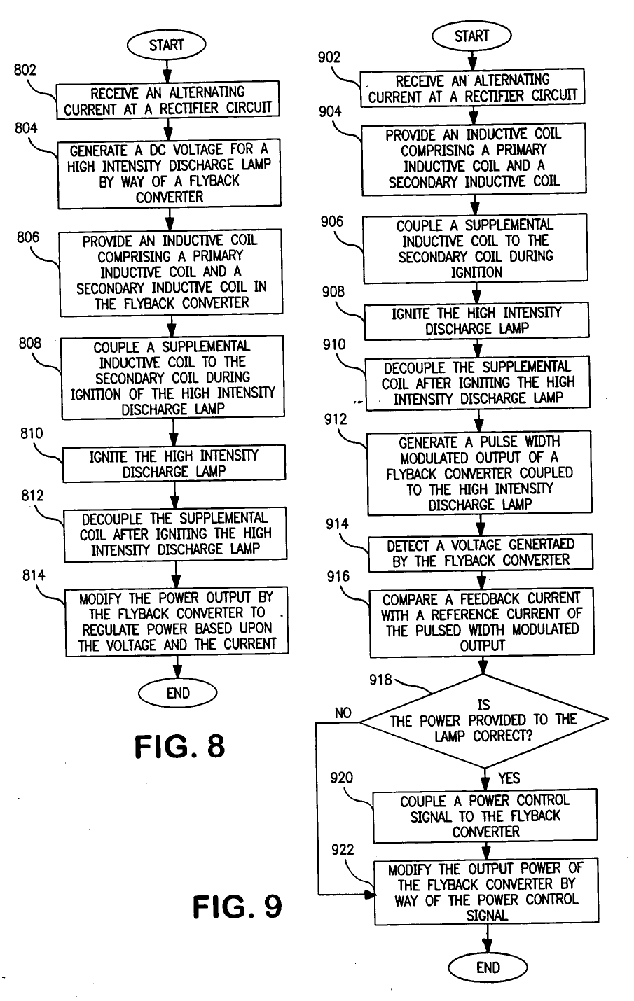

Turning now to FIG. 8, a flow diagram shows a method for igniting and powering a high intensity discharge lamp according to an embodiment of the present invention. In particular, an alternating current is received at a rectifier circuit at a step 802. A DC voltage is generated for a high intensity discharge lamp by way of a flyback converter at a step 804. An inductive winding comprising a primary inductive winding and a secondary inductive winding in the flyback converter is provided at a step 806. A supplemental inductive winding is coupled to the secondary winding during ignition at a step 808. The high intensity discharge lamp is ignited at a step 810. The supplemental winding is decoupled after igniting the high intensity discharge lamp at a step 812. The power output by the flyback converter is modified to regulate power to the lamp based upon the voltage and the current at a step 814.

Turning now to FIG. 9, a flow diagram shows a method for igniting and powering a high intensity discharge lamp according to an alternate embodiment the present invention. In particular, an alternating current is received at a rectifier circuit at a step 902. An inductive winding comprising a primary inductive winding and a secondary inductive winding is provided at a step 904. A supplemental inductive winding is coupled to the secondary winding during ignition at a step 906. The high intensity discharge lamp is then ignited at a step 908. The supplemental winding is decoupled after igniting the high intensity discharge lamp at a step 910. A pulse width modulated output of a flyback converter coupled to the high intensity discharge lamp is generated at a step 912. A voltage generated by the flyback converter is detected at a step 914. A feedback current is then compared with a reference current of the pulse width modulated output at a step 916. It is then determined whether the power provided to the lamp is correct at a step 918. If not, a power control signal is coupled to the flyback converter at a step 920. The output power of the flyback converter is modified by way of the power control signal at a step 922.

It can therefore be appreciated that a new and novel circuit and method for igniting and operating a high intensity discharge lamp has been described. It will be appreciated by those skilled in the art that numerous alternatives and equivalents will be seen to exist which incorporate the disclosed invention. As a result, the invention is not to be limited by the foregoing embodiments, but only by the following claims.

I Claim:

1. A circuit for igniting and powering a high intensity discharge lamp, said circuit comprising:
a rectifier circuit coupled to receive an alternating current line voltage;
a flyback converter coupled to said rectifier circuit, said flyback converter having an inductor comprising a primary inductive winding and a secondary inductive winding; and
an open circuit voltage circuit coupled to said secondary inductive winding, said open circuit voltage circuit coupling a supplemental inductive winding to said secondary inductive winding during ignition of said high intensity discharge lamp.

2. The circuit of claim 1, wherein said open circuit voltage circuit further comprises a switch for decoupling and coupling said supplemental inductive winding to said secondary inductive winding.

3. The circuit of claim 1, further comprising a power control circuit coupled to said flyback converter, said power control circuit coupling a power control signal to said flyback converter.

4. The circuit of claim 4, wherein said power control signal regulates the power output by said flyback converter.

5. The circuit of claim 5, wherein said power control signals comprises a signal for controlling the duty cycle of a power transistor of said flyback converter.

6. A circuit for igniting and powering a high intensity discharge lamp, said circuit comprising:
rectifier means coupled to receive an alternating current line voltage;
flyback converter means coupled to said rectifier means, said flyback converter means comprising a first means for generating a feedback output voltage and a second means for generating a feedback output current;
open circuit voltage means coupled to said flyback converter means for reducing the voltage stress on said primary winding during ignition;
voltage detector means coupled to receive said feedback output voltage;
current detector means coupled to receive said feedback output current;
control circuit means coupled to said voltage detector means and said current detector means; and
power control feedback means coupled to said control circuit means, said power control feedback means coupling a power control signal to said flyback converter means.

7. The circuit of claim 6, further comprising an inverter means having an ignitor for igniting said high intensity discharge lamp.

8. The circuit of claim 7, further comprising an inverter driver means for regulating said inverter means.

9. The circuit of claim 6, further comprising a flyback converter control means.

10. A method of igniting and powering a high intensity discharge lamp, said method comprising the steps of:
generating a DC voltage for said high intensity discharge lamp by way of a flyback converter;
providing a flyback transformer in said flyback converter, said flyback transformer comprising a primary inductive winding, a secondary inductive winding, and a supplemental inductive winding; and
coupling said supplemental inductive winding to said secondary winding to ignite said high intensity discharge lamp.

11. The method of claim 10, wherein said step of coupling said supplemental winding to said secondary winding comprises switching said supplemental winding into a circuit for generating an enhanced DC bus voltage during said ignition of said high intensity discharge lamp.

12. The method of claim 10, further comprising a step of decoupling said supplemental winding from said secondary winding after igniting said high intensity discharge lamp.

13. The method of claim 12, further comprising a step of modifying the power output by said flyback converter based upon the voltage and current generated by said flyback circuit.

14. A method of igniting and operating a high intensity discharge lamp, said method comprising the steps of:
providing a flyback converter with a flyback transformer comprising a primary inductive winding, a secondary inductive winding, and a supplemental inductive winding;
coupling said supplemental inductive winding to said secondary winding to ignite said lamp;
decoupling said supplemental winding from said secondary winding after ignition of said lamp;
generating a pulse width modulated output of said flyback converter coupled to said high intensity discharge lamp;
detecting a voltage generated by said flyback converter;
detecting the current of said pulse width modulated output; and
coupling a power control signal based upon said voltage and said current to said flyback converter.

15. The method of claim 14, further comprising a step of modifying said pulse width modulated output of said flyback converter by way of said power control signal.
